(19) United States
(12) Patent Application Publication
(10) Pub. No.: US 2002/0164020 A1
(43) Pub. Date: Nov. 7, 2002

(54) System and method for encrypting and decrypting information through the use of random numbers

(76) Inventor: Shakeel Mustafa, Tustin, CA (US)

Correspondence Address: SHAKEEL MUSTAFA, 15520 TUSTIN VILLAGE WAY Apt. # 2, TUSTIN, CA, 92780, US

(21) Appl. No.: 09/848,670

(22) Filed: May 4, 2001

(51) Int. Cl. H04K 1/00

(52) U.S. Cl. 380/46

(57) ABSTRACT

The present invention provides a simple but extremely robust encryption method and system for encrypting any type digital information consisted of any arbitrary length. A host can simultaneously maintain plurality of encrypted communication sessions with several remotes. A pre-determined number of bits located at pre-determined and specific positions within a seed arbitrary bit segment of any length determine a random sequence of mathematical or logical functions that can be used to encrypt a digital information segment. A sequence of randomly selected functions is used every time a new digital information segment consisting of any arbitrary length needs to be encrypted. The resulting encrypted information segment does not contain any indication about the plurality of functions used in its encryption process. The invention also provides unique ways of updating and modifying the encryption/decryption procedures even during the course of an on-going communication session.

### BACKGROUND OF THE INVENTION

The present invention relates to data encryption, and more particularly to the improvements in processing efficiency of the encryption and decryption of digital information. Furthermore, the present invention relates to encryption involving any type of digital information, and to the improvements in processing efficiency of the encryption and decryption of digital information. The major problem which exists with current encryption methods is that of speed. As the level of encryption complexity increases, the processing speed requirements also increase by many folds.

Encryption and Decryption techniques can be categorized into two major flavors: Symmetric and Asymmetric. Symmetric, or Private Key, encryption (also known as conventional encryption) is based on a secret key that is shared by both communicating parties. The sending party uses the secret key to encrypt (or encipher) plaintext to ciphertext. The receiving party uses the same secret key to decrypt (or decipher) the ciphertext to plaintext. Examples of symmetric encryption schemes are the RSA RC4 algorithm (which provides the basis for Microsoft Point-to-Point Encryption (MPPE)), Data Encryption Standard (DES), the International Data Encryption Algorithm (IDEA), and the Skipjack encryption technology proposed by the United States government (and implemented in the Clipper chip).

One of the most popular encryption technique DES algorithm which uses symmetric key is sadly out of date. It is currently reasonably difficult to extract a key from a session (it usually takes around 56 hours) but that is hardly secure at all. Triple-DES is a technique whereby a message is encrypted three times: Either the message is repeatedly encrypted by two keys, or the message is encrypted by three different keys. Triple DES runs three times slower than standard DES.

An asymmetric encryption system utilizes two keys, one called a public key (which is known to both the sender and the recipient of encrypted data), and the other, called a private key (known only to the individual sending the data). The private and public keys are mathematically related by the encryption algorithm. One key is used for encryption and the other for decryption depending on the nature of the communication service being implemented.

The huge advantage of this system is that a public key can be freely distributed on the Internet without losing security in any way. The massive disadvantage is that encrypting and decrypting is very slow. DES and other symmetric algorithms are generally between 100 and 10,000 times faster than asymmetric algorithms. The most common technique used for asymmetric encryption was invented in 1977 by Ron Rivest, Adi Shamir, and Leonard Adleman. Their method is called RSA and its inventors subsequently formed RSA Labs in 1982.

Neither system just described above is ideal. Symmetric algorithms are fast and reasonably secure but making sure that two people have the same key, and that only they have the keys, is a problem. The DES technology requires the same key to be used for encryption and decryption. If a hacker is successful in extracting the DES key then the entire communication becomes insecure. The asymmetric algorithms are easy to implement over the Internet because a public key can be freely distributed on the Internet without losing security in any way. The massive disadvantage is that encrypting and decrypting is very slow.

Having said that, there is strong market demand and need for a particular technique that can encrypt/decrypt any type of digital information consisting of any arbitrary length at a very high speed, and also requires low processing power. The technique must be robust enough to withstand any brutal and powerful attempts to decipher the information. With the tremendous increase in the processing power of the modem computer it is an utmost requirement that the encryption technique can provide a strong deterrent from code breakers.

Also, a scheme that can provide a robust methodology for exchanging password information to authenticate individual users. In addition, a procedure for continuing authentication during a user's communication session such that the user's password is not exchanged between transmitting and receiving devices.

### SUMMARY OF THE INVENTION

Therefore, the object of the present invention is to provide a digital information processing method that encrypts information from a plurality of remote processors to a host processor or vice versa. In the presented encryption technique a host and a remote processor, before the start of the encryption procedures, assign and mutually agree upon a certain number of pre-determined bits that are located at pre-determined and specific positions, called Group and Function Bits, of a seed binary bit segment consisting of arbitrary length. The host and the remote also mutually define a first function pool that contains a plurality of mathematical or logical functions of any complexity. Further, the said host and the remote define a second function pool that also contains any type of mathematical or logical functions of any complexity with the condition that there exist a unique inverse mathematical or logical function for each of the functions defined in the second pool. The said host and the remote establish a unique and one to one correspondence or relation between the functions defined in the first pool to the functions defined in the second pool with sequentially identical entries at both the host and the remote.

As an encryption/decryption session between a given remote and a host begins; the said remote generates a seed arbitrary binary bit segment that consists of any arbitrary length, retains a copy and sends the said random number segment to the host. The exact knowledge about the number of the pre-determined bits located at the predetermined positions, called Group and Function Bits, within a arbitrary binary bit segment is only known to the participating remote and the host. An eavesdropper may intercept and copy the transmission of the said binary number but cannot determine which particular bits values will be actually used for the functionality of the Group or Function Bit. Using the seed arbitrary binary bit segment the said remote identifies and reads the Group and Function Bits and generates a corresponding numeric value. The said numeric value is used to uniquely select a set of single or a plurality of mathematical or logical functions from the first function pool and another corresponding set of the functions from the second function pool. Using the function(s) identified in the second pool, the said remote encrypts any type of digital information segment consisting of any arbitrary length. Next, the remote encrypts the initial seed arbitrary binary bit segment through operating the function(s) already selected from the first pool. Based upon any type of a pre-negotiated set of rules, both the remote and the host agree in advance how to extract information either from the seed or the encrypted binary bit segment, or by any other means which determines the total number of encryption rounds (N) to be performed. For the next round of encryption, the remote processor uses the previously encrypted binary bit segment as a new seed segment and identifies the corresponding Group and Function Bits. The encryption process as described earlier is repeated on the digital information for N number of rounds.

At the receiving end the said host processor receives the seed binary bit segment, uses the mutually agreed upon set of rules to identify exactly the same set of Group and the Function Bits as identified by the remote processor. The resulting binary numeric value selects the exact same set of mathematical or logical functions from the pre-defined first and second function pools. Using the functions selected from the second pool the host processor identifies the corresponding single or a plurality of inverse functions and tabulates the entries in a sequential order in a decrypting function table. In the next step, the said host processor encrypts the seed binary bit segment using the function identified from the first function pool. In the next step, the said host determines the total number of encryption rounds (N) exactly the same way as determined by the remote. Using the encrypted binary bit segment as the new seed segment it identifies the corresponding Group and Function Bits and calculates the same numeric value as calculated by the remote. The numeric value identifies the set of mathematical or logical functions from the first pool and the second pool. The mathematical or logical functions as identified from the second pool uniquely point out towards their corresponding set of inverse functions. These identified sets of inverse functions are appended with the other entries in the decrypting function table. The above procedure is repeated for ‘N’ number of rounds. At the end of the last round the decrypted function table entries contain the inverse function of every mathematical or logical function used for encrypting the digital information at the remote processor.

As the said host processor receives an encrypted digital information segment from the said remote processor, it decrypts the information segment using the last inverse function entry found in the decryption function table. This decryption process is repeated for N number of rounds and each inverse function operating on the digital information segment reverses the encryption effects introduced by its counterpart function operation at the remote processor. After the execution of all the inverse function entries found in the decrypting function table, the received encrypted digital information segment is restored to its original form as it existed before the encryption procedures were executed at the remote processor.

Another object of the present invention is to introduce a unique method for transmitting users' passwords from remote to a host or vice versa. The individual bits in a user's password information segment are diffused into an arbitrary binary bit segment through the use of a seed binary segment, and then the resulting diffused password segment is encrypted through the use of encryption techniques presented in this invention.

It is further an object of the present invention to authenticate users' communication sessions through the use of exchanging random numbers which alter frequently and are exclusively known to the participating transmitting and receiving devices.

Note: In the disclosure, the term random number and a seed binary bit segment consisting of arbitrary length is used interchangeably. By definition, a seed binary bit segment consisting of arbitrary length may appear to be a random number to an eavesdropper but the generating remote may be selectively controlling the values of single or plurality of bits assigned for the role of Group or Function Bits. Using this scheme, the remote processor can have the flexibility to first select the sequence of functions more appropriate for performing encryption on a certain type and length of a digital information segment and then set the values of the corresponding Group and Function Bits. On the other hand, a random number randomly assigns the Group and Function Bits values and based on the said values the functions are selected.

### BRIEF DESCRIPTION OF THE DRAWINGS

The invention will be better understood with its objectives when consideration is given to the following detailed description thereof. Such a description makes reference to the annexed drawings wherein:

FIG. 1 illustrates a host which communicates to a plurality of remote devices through unsecured communication channels.

FIG. 2 presents a typical communication session between a host and remote based on the techniques presented in this invention.

FIG. 3 illustrates an example of a plurality of mathematical or logical functions defined in the first and second function pools with a unique one-to-one relationship.

FIG. 4A shows a variable size random number within a certain bit length range containing a predetermined number of bits that are located at pre-determined and specific locations within the said random number, representing Group Bits, with respect to the defined boundaries.

FIG. 4B is a table representing the numeric values of Group Bits, the corresponding number of Function Bits assigned, and their pre-determined and specific locations within the said random number.

FIG. 5A, 5B and 5C illustrate the exact position of the specific and individual Function Bits belonging to a particular Group Number from a well defined start or ending boundaries.

FIG. 6 is a table showing all the possible numeric Function Bits values along with their corresponding association with the sequence of logical and mathematical functions belonging to the first function pool.

FIG. 7 shows a table which represents the relationship between a set of binary numbers and the total number of rounds of encryption to be performed.

FIGS. 8A and 8B illustrate an example of a function operation and its inverse function operation on an information segment.

FIG. 9 depicts the encryption technique using the random number and a set of logical and mathematical functions.

FIG. 10 illustrates the decryption technique utilizing the random number and the inverse logical and mathematical functions.

FIG. 11 shows exemplary frame formats that can be used to exchange configuration parameters and system information between a host and a remote processor.

FIGS. 12A & B illustrate a transparent and non-transparent means of exchanging a random number between a host and a remote processor.

FIG. 13 shows a method for diffusing the individual bits of information belonging to a password segment into an arbitrary binary bit segment.

FIG. 14 shows a table used by the mapping algorithm to diffuse the individual bits of information in a password segment.

### DETAILED DESCRIPTION OF THE PREFERRED EMBODIMENTS

The following discussion concerning an encryption process is merely exemplary in nature and is in no way intended to limit the invention or its applications or uses.

The main object of the presented invention is to provide a highly reliable encryption technique that can be utilized in an unsecured communication channel. The scheme is designed with the consideration that eavesdroppers equipped with high processing power computers may have the ability to intercept or even redirect or hijack, an on-going communication session between two legitimate and trusted entities.

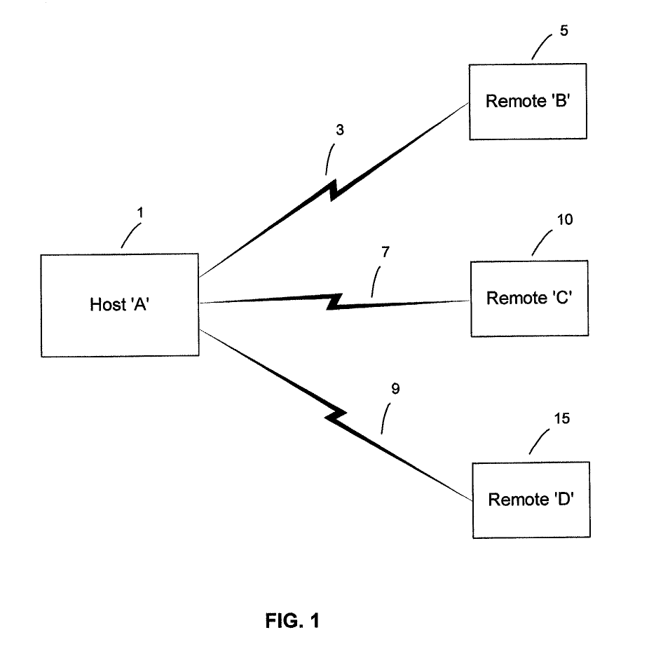

Referring to the diagram illustrated in FIG. 1, a host ‘A’ 1 is connected to a plurality of remotes (remote ‘B’ 5, remote ‘C’ 10, and remote ‘D’ 15) through multiple unsecured communication channels 3, 7, and 9, respectively. During any communication session, the host ‘A’ 1 maintains a different set of encryption schemes to communicate with each of the individual said remotes.

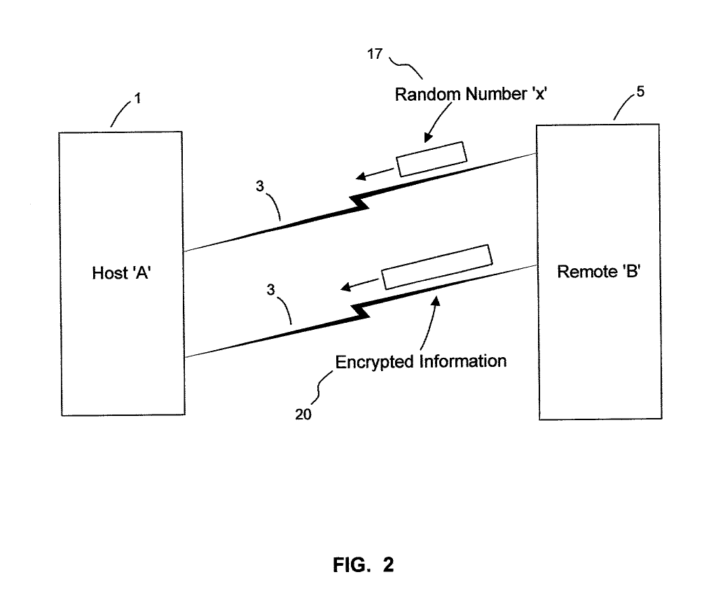

For simplicity and clarification, the communication scenario between the host ‘A’ 1 and the remote ‘B’ 5 will be described with reference to the presented encryption techniques herein as an example. The said host can independently and simultaneously maintain different communication sessions with a plurality of remotes. The host ‘A’ 1 can utilize the same encryption techniques to maintain the individual communication sessions between a plurality of remotes. FIG. 2 illustrates a scenario where the remote ‘B’ 5 establishes a communication session with the host ‘A’ 1 through the unsecured communication link 3. A random number ‘x’ 17 is transmitted from the remote ‘B’ 5 followed by any number of encrypted information segments all destined to the host ‘A’ 1.

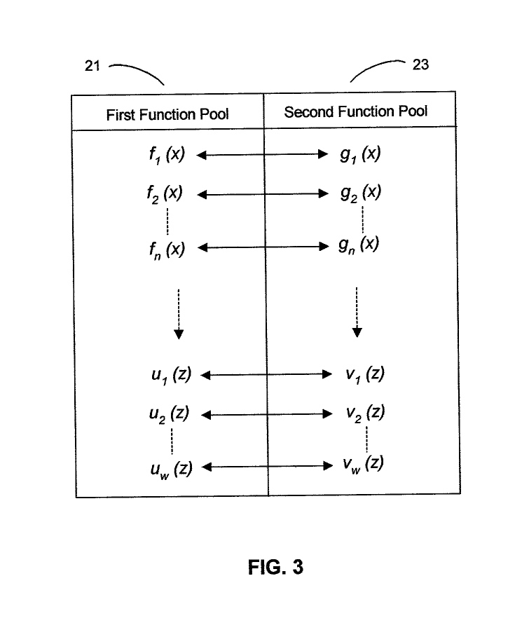

Before a communication session can utilize the encryption techniques discussed herein the host ‘A’ 1 and the remote ‘B’ 5 define two sets of function pools. As illustrated in FIG. 3, the first function pool 21 contains a plurality of functions, e.g., f₁i(x) to u_{W}(z), which may constitute any type of mathematical or logical functions of any complexity. It is desired that the functions be chosen in the first pool in such a way that when the said single or plurality of functions are operated on a random number ‘x’ they yield a higher degree of randomness in the said random number.

The second function pool 23 contains another class of plurality of functions, e.g., g₁(x) to V_{W}(Z), with the criteria such that there exists a unique inverse function for each of the functions defined in the second pool. By definition, the result of a function can be restored to its original value through its inverse function. Mathematically speaking, a function H(x)=y has its inverse function (H⁻¹) if H⁻¹(y)=x. The common examples of reversible functions are addition, with its inverse as subtraction; right rotation function with its inverse as left rotation function, etc. The solutions to linear and polynomial equations can also be categorized as reversible functions only if a predetermined unique solution (single root of the equation) is chosen at both sides. The functions defined in the second pool can also be consist of any type of mathematical or logical functions of any complexity with the condition that there must exist an inverse function for every function defined in the said pool. Each of the function defined in the first pool uniquely correspond to a function defined in the second pool.

As will be discussed in detail in the later sections, that the functions defined in the second pool are utilized to encrypt any type of digital information segment consisting of any arbitrary length. For this reason, it is highly desirable to select the specific classes of mathematical or logical functions defined in the second function pool 23 such that their operations produce highly diffusive and random characteristics in a relatively large segment of digital information containing user's information. The host ‘A’ 1 and remote ‘B’ 5 contain the exact and identical copies of both the first and second function pool tables.

The next step in the initial setup phase involves the definition and the use of Group and Function Bits. The Group and Function Bits represent a predetermined number of bits that are located at pre-determined and specific positions within a random number consisting of any arbitrary length. The participating host ‘A’ 1 and the remote ‘B’ 5 can mutually agree in advance to utilize any type of mathematical or logical function(s) that can be used to identify the allocated positions of the Group and Function Bits.

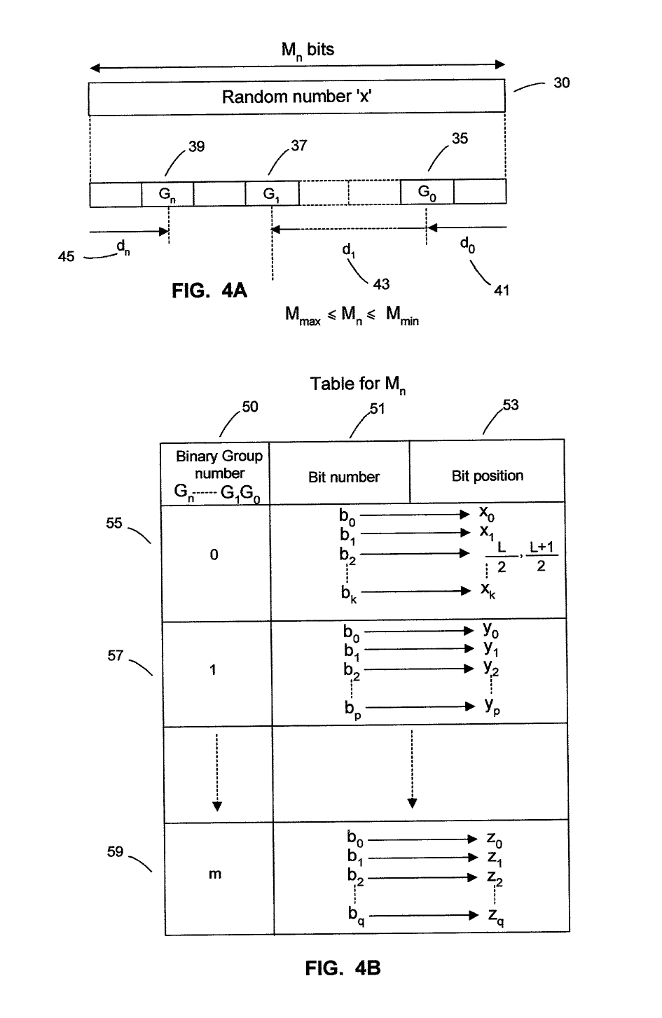

FIG. 4A visually demonstrates how the structure of a random number ‘x’ 30 at the individual bit level is interpreted. The random number ‘x’ 30 can consist of any number of Mₙ bits ranging from a minimum Mₘᵢₙ bits to Mₘₐₓ number of bits. As illustrated in FIG. 4A, the location of the ‘n’ number of specific bits G₀ 35, G₁ 37, . . . Gₙ 39, known as Group bits, is well defined and recognized in advance during the system initialization phase by the bit vector distance d₀ 41, d₁ 43, . . . dₙ 45 respectively. The set of rules that are used to identify their unique positions in the random number ‘x’ 30 are shared in advanced by the host ‘A’ 1 and the remote ‘B’ 5. As both the said host and the remote identify the position of the Group bits, they read the respective bit values and produce the numeric result in the form of a binary Group Number. It is logical to infer that the resulting binary Group Number will be exactly the same at both the said host and the remote since they both use the same set of rules to identify the Group Bits in the given random number ‘x’ 30.

FIG. 4B maintains this information in a tabular form with column 50 representing all the possible numbers that can be generated by the binary Group Number for a random number of length Mₙ such that Mₘₐₓ≦Mₙ≦Mₘᵢₙ. In one embodiment, the host ‘A’ 1 and remote ‘B’ 5 can maintain multiple tables with each table specifically designed to handle a random number of a particular size. In this case the total number and the position of each individual bit assigned to represent the role of Group Bits will depend on the length of the random number. This scheme can make it very difficult for an eavesdropper to guess the total number and position of Group Bits since each random number will carry this information differently. The range covered by a Binary Group Number depends on the number of bits assigned as Group Bits in a given random number. With 8-bits assigned to Group Bits, the total number of possibilities that a Group Number can have spans from 0 to 255. Each of the Binary Group Numbers, in turn, correspond to a set of pre-assigned bit numbers, b₀, b₁ . . . bₖ, known as Function Bits, shown in column 51 of FIG. 4B. The next column 53 uniquely tells the system about the total number of Function Bits assigned along with a set of rules to determine the position of the individual Function Bit in a given random number.

The relationship between a Function bit and its corresponding unique location in a given random number can mutually be recognized through the use of any type of pre-negotiated or pre-determined set of rules. For illustration purposes, only simple length relations are shown to locate a Function Bit position in the given random number ‘x’ 30. It should be noted that a binary Group Number can contain any arbitrary number of Function Bits in it. As similar to Group Bits, the position of each of the individual Function Bit is uniquely mapped to a distance vector xₖ. The distance vector, xₖ, is measured in bits from pre-negotiated boundaries or through a mutually agreed set of rules. For example, a Function Bit location can be based on a simple division of the length of a given random number.

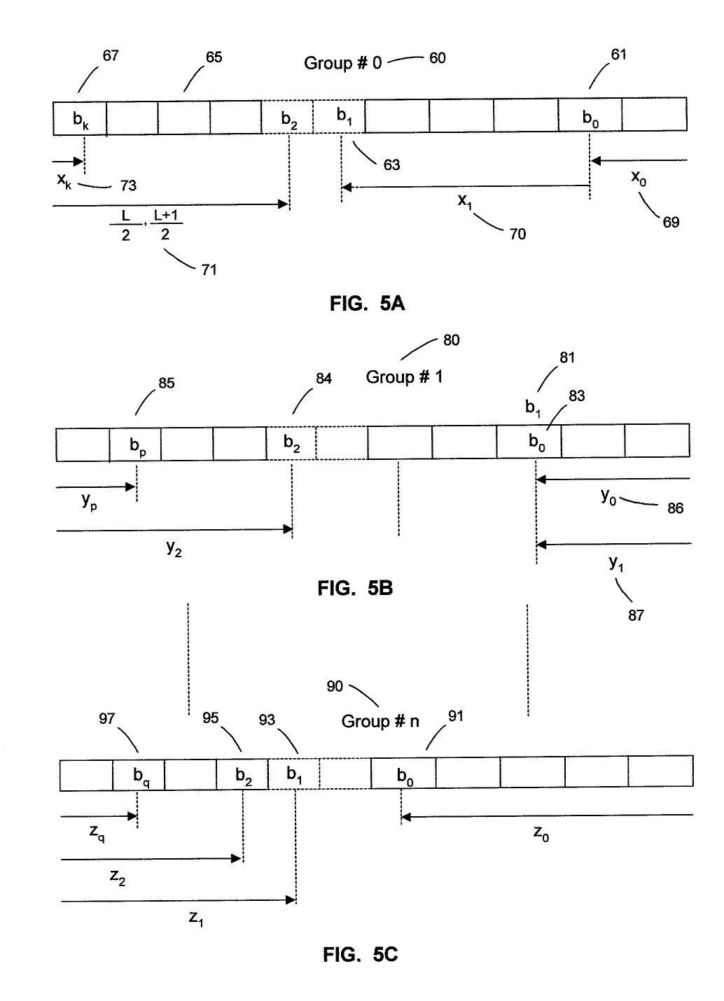

FIGS. 5A, 5B, and 5C demonstrate this concept in more detail. FIG. 5A represents the Function Bits entries for the Group #1. As shown, the location of the bit b₀ 61 is measured as x₀ number of bits away from the start boundary of the random number ‘x’ 30. Similarly, the location of the next bit b₁ 63 is known to the system as x₁ number of bits away from the bit b₀ 69 position. Further, the system can find the position of the bit b₂ 65 as a bit located exactly in the middle of the random number ‘x’ 30 consisting of length L. As illustrated in FIG. 5A, if the said random number consists of even bits, then the position of the bit b₂ 65 is located as L/2 bits away from the ending boundary. If the said random number contains an odd number of bits then the bit b₂ 65 position can be identified as (L+1)/2 from the ending boundary.

Referring back to column 50 in FIG. 4B, the Group Number entry 57 represents the binary Group value of 1 and this number picks b₀, b₁, b₂ . . . bₚ (‘p’ represents the total number of Function Bits) with each of the individual bit positions corresponding to y₀, y₁, y₂, . . . yₚ from pre-defined boundary lines, respectively. This is shown in FIG. 5B under the Group # 1, 80. It should be noted that each of the individual Group or Function Bits does not have to be located at a different bit location. Two or more Group or Function Bits can occupy the same bit position. This is shown in FIG. 5B where the two Function Bits b₀ 83 and b₁ 81 occupy the same bit location as identified by y₀ 86 or y₁ 87. FIG. 5C shows the Group # n which has allocated ‘q’ number of Functions Bits in the random number ‘x’ 30. Each of the bit location is determined by the respective distance vector numbers, e.g., z₀ to z_{q}, similar to the manner as discussed above.

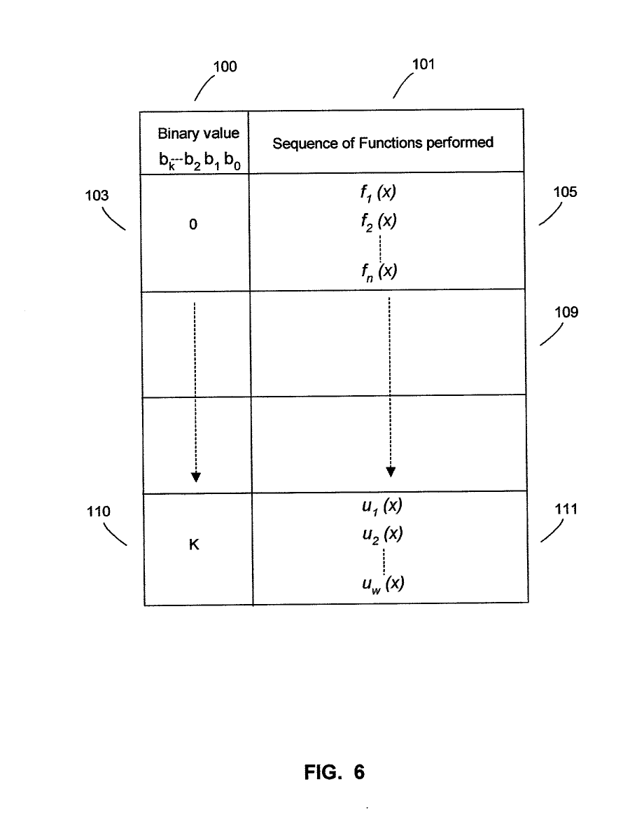

FIG. 6 maintains the range of all the possible numeric values of the binary numbers (bₖ, . . . b₂, b₁, b₀) resulting from a given set of Function Bits in a tabular form as shown in column 100. Each possible binary numeric value is associated with a pre-arranged sequence of mathematical or logical functions selected from the function class defined in the first pool. As illustrated in FIG. 6, a resulting binary value of 0 indicated by the table entry 103 corresponds to a sequence of mathematical or logical functions (f₁ (x), f₂ (x) . . . fₙ (x)). Similarly, each resulting numeric value of the Function Bits uniquely corresponds to a single or plurality of the pre-arranged functions.

As it follows from the above discussion, the participating host ‘A’ 1 and the remote ‘B’ 5 engaged in a communication session mutually agree in advance about the specific locations of bits in a random number which are designated as Group or Function Bits. Any single or plurality of bit value change in the assigned Group Bits produces a different binary Group Number. As a result a different number of bits assigned for the role of Function Bits will be identified with each Function Bit located at a specific position in a given random number. The resulting binary numeric value in turn may point towards the selection of a different sequence of functions.

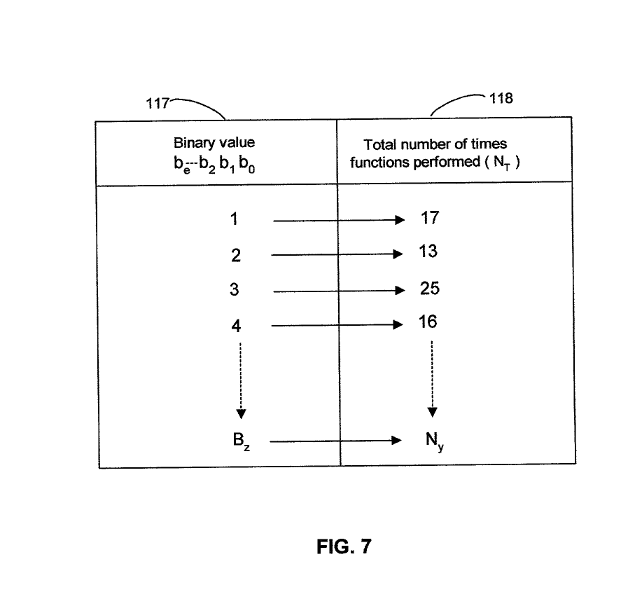

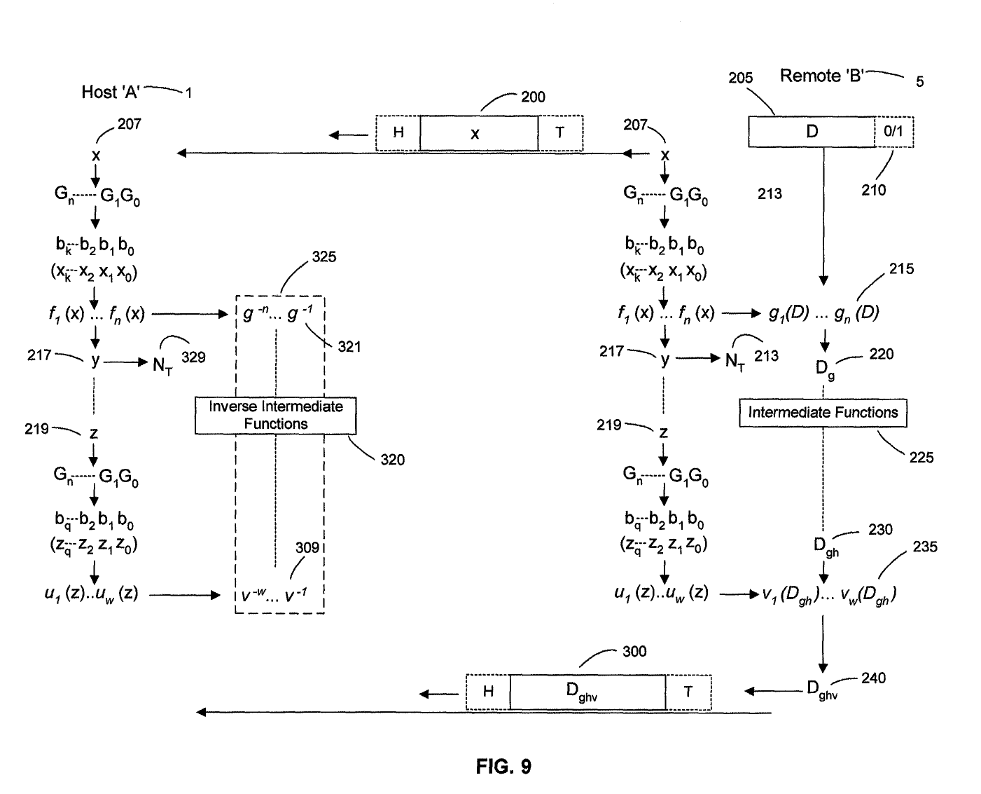

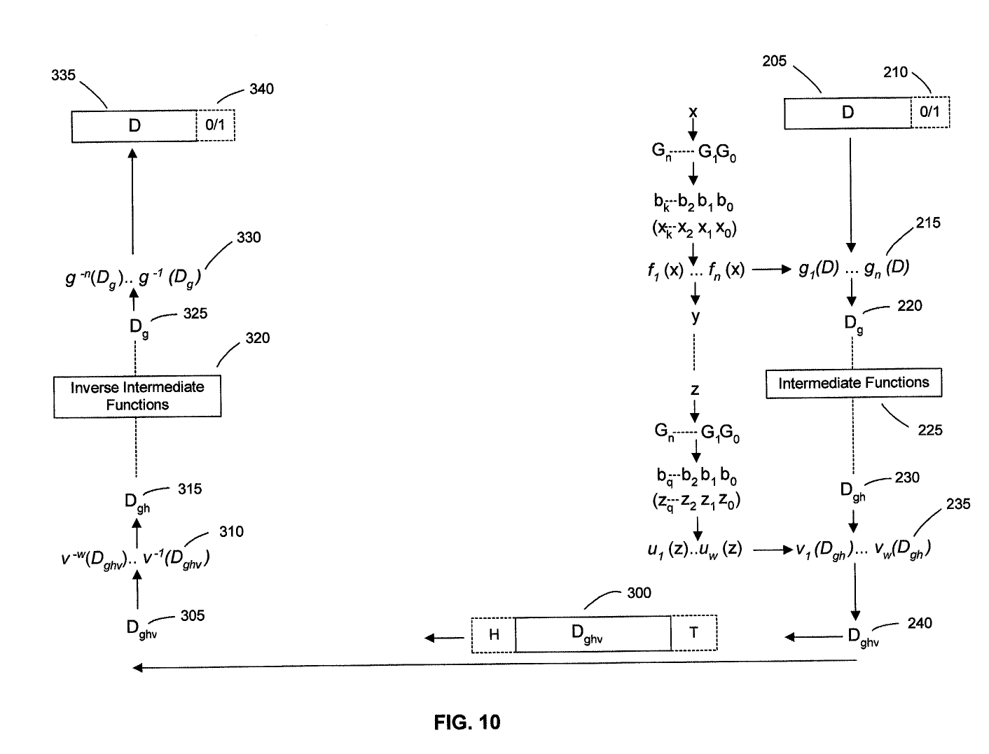

FIG. 7 illustrates a table that consists of two columns. The first column contains numeric binary value 117 that is based on the values of pre-selected bits in a random number. Each numeric value uniquely corresponds to a number in column 118. The resulting number in column 118 determines the total number of encryption rounds at the remote ‘B’ 5 and exactly the same number of decryption rounds at the host ‘A’ 1. In other words, both host ‘A’ 1 and the remote ‘B’ 5 mutually agree upon the number of encryption/decryption rounds that need to be performed on a digital information segment. The number count includes the total number of repeated operations of the same or different sets of functions. The use of this feature will become apparent with respect to the encryption procedure described in reference to FIGS. 9 and 10.

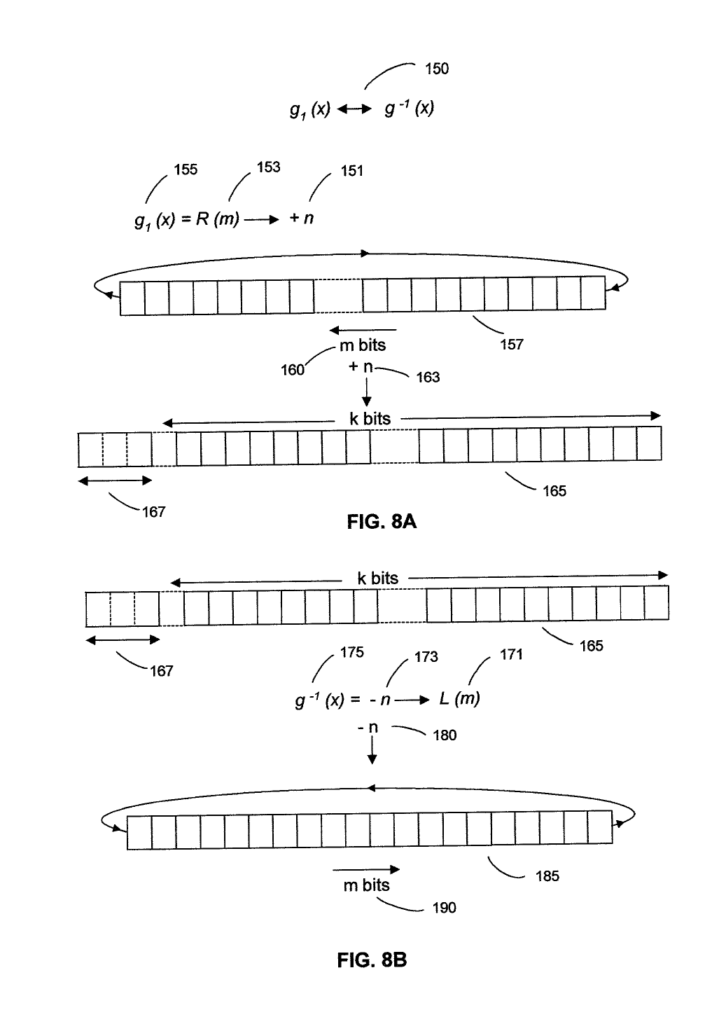

FIGS. 8A and 8B illustrate an example of a function operation followed by its corresponding inverse function operation on a digital information segment of an arbitrary length. In the presented example, the operation of the function g₁(x) 155 consists of two operators. The first operator R(m) 153 rotates the bits contained in the information segment 157 towards the right to an equivalent number of ‘m’ bits, 160. In the next step, the second operator 151 adds a binary number ‘n’ 163 to the already rotated information segment resulting in an encrypted information segment 165 consisting of k number of bits. It should be observed that depending upon the type of operations performed on the digital information segment the resulting length of the encrypted information segment could be more or less than the original segment. This difference can be consisted of single or multiple bits. Generally, the digital information is processed and exchanged among the communication layers in term of multiple bytes (8 bits/byte). To ensure that the encrypted information segment is consisted of multiple bytes, a padding header followed by a certain number of padding bits is appended. As shown in FIG. 8A, the padding header 167 consisted of 3 bits indicates that how many padding bits are inserted to make the total encrypted information segment length to be divisible by eight bits or any other number.

FIG. 8B illustrates the operation of the inverse function of g₁(x), represented as g⁻¹ (x) 175, on the encrypted information segment 165. The inverse function g⁻¹ (x) 175, by its definition, contains all the necessary operators that can reverse the effects of the operations performed by the function g₁(x). In this sense, the inverse function g⁻¹ (x) 175 is consisted of two operators; the first operator 173 represents a subtraction of number ‘n’ while the second operator 171 represents a left rotation equivalent to ‘m’ number of bits. As the encrypted information segment is processed for decryption the first step is to remove the padding header 167 along with the associated bits. Next, the operator 173 subtracts the number ‘n’ from the encrypted information segment 165. As a final step the operator L(m) 171 rotates the said segment towards the left to an equivalent of ‘m’ bits. The resulting information segment 185 is exactly the same as the information segment 157 before the encryption process. It is evident from this example that the contents of any information segment consisted of any arbitrary length remains unchanged first by the operation of the function g₁(x) and then by the operation of its inverse function g⁻¹(x).

The above example is presented through the use of simple operators only for the purpose of illustration. Any type of mathematical or logical function or operator of any complexity can be used in this procedure as long as there exists a unique inverse function for the selected function.

FIG. 9 demonstrates the encryption methodology presented in this invention. The remote ‘B’ 5 needs to send a digital information segment 205 consisted of any arbitrary length to the host ‘A’ 1. As discussed previously, both the host ‘A’ 1 and the remote ‘B’ 5 maintain the exact same configuration parameters to be used for encryption/decryption procedures. Both the said systems not only exchange user's digital information but also exchange system configuration parameters in the encrypted form necessary for proper operation. In order to distinguish between a system and user's digital information segment a single bit field 210 is appended with the original information segment. The first value of the said bit field (e.g., 1) identifies a system information segment whereas the second bit value (e.g., 0) can be used to identify a user's information segment. As a first step in the encryption procedure, the said remote generates a variable size random number ‘x’ within a given length range of a minimum and maximum number of bits. The said random number ‘x’ is sent to the host ‘A’ 1 in a packet format 200. It should be observed that it is the responsibility of the transport and the lower level communication layers to guarantee the successfully delivery of any information exchange between the host ‘A’ 1 and remote ‘B’ 5. The surrounded header and trailer fields shown in the packet format 200 represent a typical communication overhead added by the lower level of communication layers to process the packet properly for its delivery to the host ‘A’ 1. Therefore, if the packet 200 does not reach the remote host ‘A’ 1 the transport mechanism at the remote ‘A’ 5 will continue to re-transmit the said packet until it gets a successful notification from its peer transport layer at the said host.

Both the host ‘A’ 1 and remote ‘B’ 5 process the random number ‘x’ 207. First, both the said systems locate the group bits (Gₙ . . . G₁G₀) in the random number ‘x’ 207 using a pre-established set of rules and then determine the resulting binary value of the Group Number as discussed earlier with reference to FIGS. 4A and 4B. Since the both said systems are using exactly the same set of rules, therefore, they both identify the same binary Group Number value from the said random number ‘x’. The binary Group Number in turn points to the predetermined Function Bit locations in the said random number. A predetermined number of bits (bₑ, . . . b₂, b₁, b₀) are used to determine the number N_{T} which instructs both said systems about the total number of function reiterations to be performed.

The both host ‘A’ 1 and the remote ‘B’ 5 determine the Function Bits location and yield the exact same binary numeric number. The resulting binary numeric number points towards a single function or a sequence of functions as shown previously in FIG. 6 for both said systems.

Referring back to FIG. 9, which illustrates that the remote ‘B’ 5 uses the resulting binary numeric value and refers to the table shown in FIG. 6 to identify the corresponding functions (f₁ (x), f₂ (x) . . . fₙ (x)) belonging to the first function pool. Once the functions in the first function pool are identified the corresponding functions in the second pool (g₁ (x) . . . gₙ (x)) can be easily identified from the table given in FIG. 3. The information segment ‘D’ 205 can either contain system or the user's information. As will be discussed later in the section, the system information is typically used to exchange a modified or updated set of rules associated with Group Bits, Function Bits, mathematical and logical functions, etc. The distinction between user's information and system information is made through the use of a single inserted bit 210. A bit value of 0 represents a user's information segment whereas a bit value of 1 means a system information segment. The plurality of functions identified in the second pool (g₁ (x) . . . gₙ (x)) operate on the information segment ‘S’ as shown in step 215 and produce the first encrypted information segment D_{g} 220.

The plurality of the functions identified from the first function pool f₁ (x), f₂ (x) . . . fₙ (x) operate on the random number ‘x’ 207, modify the characteristics of the said random number and produce another number ‘y’ 217. The modified random number ‘y’ 217 replaces the previous random number ‘x’ 207 and is processed as the new seed random number for the next encryption cycle. It should be noted that the modified random number ‘y’ 217 is not exchanged between the host ‘A’ 1 and the remote ‘B’ 5. As follows from the preceding discussion, it is necessary that both the said host and the remote must agree in advance about the number of encryption cycles to be performed. This information can be mutually configured in a number of ways. In one embodiment, a pre-determined number of bits located at predetermined bit positions within the modified random number ‘y’ 217, similar to Function or Group Bits, can be mutually reserved. As shown in FIG. 7, the numeric binary value of the pre-selected number of bits (bₑ . . . b₂, b₁, b₀) listed in column 117 uniquely corresponds to a number N_{T} in column 118 which determines the total number of encryption cycles to be performed. Since the number ‘y’ 217 by itself is not exchanged over the communication channel it makes it extremely difficult for a hacker to guess about the number of encryption rounds performed on any given information segment. As it is evident, a person skilled in the art may choose another way to collaborate this information at the both said host and the remote. Nevertheless, any of the these techniques falls under the scope of the presented invention.

Referring back to FIG. 9, this encryption procedure is repeated N_{T} number of times. Each new encryption cycle uses the modified random number produced from the previous routine as a seed random number. The corresponding numeric value of the Group and Function Bits selects a new set of unique functions from the first and second function pools. The functions identified in the first function pool encrypt the random number further produced from the previous encryption cycle. The corresponding functions identified in the second function pool further encrypts the information segment. These encryption rounds are repeated as illustrated in step 221. As illustrated in the FIG. 9 the last encryption round, N_{T}, produces the seed random number ‘z’ 219. The corresponding numeric value derived from the Group and Function Bits of the said seed number chooses a sequence of functions, u_{I}(z) . . . u_{W}(z), from the first pool. The corresponding functions identified from the second pool operate on the already encrypted information segment D_{gh} 230 in step 235 to produce a further encrypted information segment resulting as D_{ghv} 240. It should be noted that any further encryption process stops after the execution of N_{T} number of encryption rounds. A padding header with the appropriate number of padding bits is appended, if necessary, to convert the said encrypted information segment so it is divisible by a desired number. The resulting segment is passed down to the lower communication layers for a reliable delivery to said host ‘A’ 1. The packet 300 carries the encrypted segment D_{ghv} with the appropriate header (H) and trailer (T) appended by the lower communication layers for proper delivery. As pointed out earlier it is the responsibility of the lower communication layers to guarantee the transmission of packet 300 to its final destination host ‘A’ 1.

Now referring to the host side of FIG. 9, the host ‘A’ 1 receives the random number ‘x’ contained in packet 200. During the information delivery process the lower level communication layers ensure that the contents of the packet are unchanged. As the said random number is processed it yields the exact same Group Number resulting from the Group Bits as produced by the remote ‘B’ 5. The Function Bits and their corresponding numeric value are also the same as well. Since the resulting binary numeric value is the same, the functions (f₁(x) . . . fₙ (x)) selected from the first pool and the corresponding functions (g₁(x) . . . gₙ(x)) identified from the second pool will also be the same as used by remote ‘B’ 5 in its first encryption cycle. Remote ‘B’ 5 identifies the inverse functions corresponding to each of the functions selected from the second pool. The resulting sequence of identified inverse functions (g⁻¹ . . . g⁻ⁿ) are tabulated in the opposite order (g⁻ⁿ . . . g⁻¹) in a decrypting function table 325. The selected functions from the first pool (f₁(x) . . . fₙ (x)) operate on the random number ‘x’ 207 to produce the next number ‘y’ 217. It should be noted that the resulting number ‘y’ 217 is exactly the same on the both host ‘A’ 1 and remote ‘B’ 5 sides since it results from the same operations performed on the random number ‘x’ 207.

As explained earlier with reference to FIG. 7, the host ‘A’ 1 also determines the number N_{T} 329 exactly through the same procedure as used by the remote ‘B’ 5. The both said host and the remote come up with the same number N_{T}, since they both use exactly the same bits (bₑ . . . b₂ b₁ b₀) value from the number ‘y’ 217 and also consult the identical table. In the next round of the encryption cycle the number ‘y’ 217 is used as a seed random number. The corresponding Group and the Function Bits are identified and then subsequently the sequence of functions from the first and the second pool are identified. The inverse of each of the functions identified in the second pool are appended in the decryption function table 325 in the opposite order. The same procedure is repeated for N_{T} times and at the end of each round the resulting inverse functions are identified and tabulated in the decryption function table 325. Although no information segment has been received yet from remote ‘B’ 5 for decryption, but the inverse functions populated in the decryption function table 325 are ready to perform an exact opposite sequence of operations on any digital information segment that may receive from the remote ‘B’ 5.

As the part of the last encryption cycle the original seed random number ‘x’ 207 is changed to a number ‘z’ 219 which is also exactly the same number ‘z’ 219 as resulted at remote ‘B’ 5. This implies that host ‘A’ 1 will also select the same sequence of functions u₁(z) . . . uₙ (z) and the corresponding inverse functions in the opposite order (y⁻ⁿ . . . y⁻¹) which will be tabulated accordingly in the decryption function table 325.

FIG. 10 illustrates the step by step decryption process as the encrypted information segment D_{ghv} carried in packet 300 arrives at the host ‘A’ 1. Once the lower communication layers successfully deliver the said packet the host ‘A’ 1 initializes the operation of the inverse functions already tabulated in the decryption function table 325. The last inverse function entries placed in the decryption function table (v⁻ⁿ . . . v⁻¹) decrypts first the received encrypted information segment D_{ghv} 305 as illustrated in step 310. As a result, this operation removes the encryption from the segment D_{ghv} 305 as introduced by its counterpart function operation 235 at the remote ‘B’ 5. After the operation of step 310 the information segment is now decrypted to a level D_{gh} 315. This process is repeated using all the inverse function entries stored in the decryption function table 325. The intermediate sequence of inverse functions 320, which is equivalent but opposite in operation of the function box 225, further decrypt the received information segment. As the last step the inverse function entries (g⁻ⁿ . . . g⁻¹) decrypt the information segment D_{g} 325 illustrated in step 330 and restore the original information segment 335. The information segment 335 and 205 are exactly the same. The value of the bit field 340 is also restored to its original transmitted value 210. As mentioned earlier, if the bit value of 340 is 0 then the said host treats the information segment 335 as a user's data segment and delivers accordingly. On the other hand, if the bit field 340 is set to 1 then this indicates system information and is processed accordingly.

It should be observed that it is not necessary for remote ‘B’ 5 to send a new seed random number in advance every time a new information segment needs to be encrypted and transmitted to the said host. The random number generated in the last encryption cycle (after N_{T} cycles) at both said host and the remote can be preserved. This number already known to both the said remote and host can be treated and processed as a new seed random number for encrypting the next information segment at the said remote. This procedure not only absolve the said remote from the need of sending frequent seed random numbers but also makes it almost impossible for an eavesdropper to determine which number is being used as a seed random number for the encryption process of a new information segment. Since the preserved number has the qualities of a random number the subsequent functions selected from the first and the second function pools will also be random in nature. As a result, the new information segment will be encrypted through the use of a different sequence of functions belonging to the second pool. An eavesdropper who may even have a complete access and knowledge of all the functions defined in the first and second pool will face a formidable and impossible task of finding out the exact sequence and order of the functions utilized to encrypt an information segment. With every new information segment being encrypted the sequence and order of the functions used to encrypt the information segment will be completely different.

As it is cleared from the preceding discussion that robustness of the encryption process presented in this invention predominately depends on choosing the Group and Function Bits positions at a pre-determine locations in a seed random number. The numeric values that result from these Group and Function Bits select the set of mathematical or logical functions used for encryption. As will be appreciated by those skilled in the art that different types of digital information, based upon the contents and segment lengths, can yield to a higher level of encryption through the use of certain mathematical or logical functions. In this regard it is quite possible that remote ‘B’ 5 can first determine the type of the digital information segment that needs to be encrypted and then chooses the appropriate set of mathematical or logical functions. The said remote then determines, through the reverse procedures, how the individual bits values in the designated role of Group and Function Bits needs to be set in an arbitrary binary bit segment. The remote ‘B’ 5 transmits the seed binary bit segment to the host ‘A’ 1 after setting the said appropriate bits in it. An eavesdropper who might be intercepting the seed binary bit segment will not be able to distinguish that the said seed segment is a pure random number or a few bits in the said seed segment are selectively changed. On the other hand host ‘A’ 1 identifies the appropriate set of inverse functions and the decryption rounds, N_{T}, to decrypts the digital information segment.

The invention also provides a very secure and unique methodology that can be used to ensure that a communication session established between two authenticated and trusted parties is not diverted or highjacked by an unauthorized entity. The commonly used transport and network layer protocols, for example TCP/IP, have inherited flaws in their designs that can be manipulated by hackers to redirect an established communication session to unauthorized sites. A hacker can manage to send fictitious acknowledgements back to the transmitting device over the transport layer from an unauthorized site, thus pretending to be a legitimate receiving site.

In addition, the presented methodology also ensures that the encryption/decryption process on the participating devices is working properly and that both devices are synchronized with respect to their functionality. The said functionality includes, but is not limited to, the same interpretation of the information contained in the seed random numbers, the selection of the exact same sequence of functions from both function pools, etc. This methodology that can verify the functional synchronization between the said remote and the host is explained with reference to FIG. 10. The both remote ‘B’ 5 and the host ‘A’ 1 mutually employ a procedure in advance that can calculate a unique digital signature from the contents of an information segment before any encryption procedure is utilized.

As illustrated in FIG. 10, the remote ‘B’ 5 calculates the unique digital signature of the information segment ‘D’ 205 and also retains a copy of the said digital signature. As the encrypted information segment makes its way to the receiving host ‘A’ 1, the said host decrypts the received information segment and again calculates its digital signature. It treats the calculated digital signature value as an information segment that needs to be delivered back to the remote ‘B’ 5. Using the encryption methods described in the disclosure, it encrypts the information segment containing the digital signature and transmits it back to the remote ‘B’ 5. The said remote decrypts the information segment containing the digital signature and compare the results with its retained digital signature calculation. A matching result implies that the original information segment was properly received and processed by the intended receiving host. If the digital signature does not match then it indicates two possibilities; either the said remote encryption and the said host decryption processes are not properly synchronized or a fictitious digital signature is delivered from an unauthorized source. In either case, the remote ‘B’ 5 can invoke a preventive mechanism that may include, but is not limited to, stopping the further encryption process and transmission of any information segment to the host ‘A’ 1. It may also include immediate notification through the use of plurality of communication means to the authorized entities, logging the results and invoking any other preventive mechanism that may seem necessary.

In another embodiment, the remote ‘B’ 5 calculates the digital signature of an information segment and appends it before performing the encryption procedure. Once the receiving host ‘A’ 1 decrypts the information segment it also calculates the digital signature. The said host then compares the calculated results with the appended received results. If both results match then this implies that the encryption/decryption process is working properly. If not, then the host ‘A’ 1 can initiate any preventive procedures independent of the procedures launched at the remote ‘B’ 5.

The present invention also addresses different versatile techniques that can be utilized to enhance the encryption security procedures implemented in this invention. These techniques include periodically and mutually updating and exchanging (1) the location and/or number of designated Group Bits in a random number (2) the location and/or the number of Function Bits associated with each of the specific Group Numbers and (3) the association of a particular function with a unique binary numeric value resulting from Function Bits as illustrated in FIG. 6.

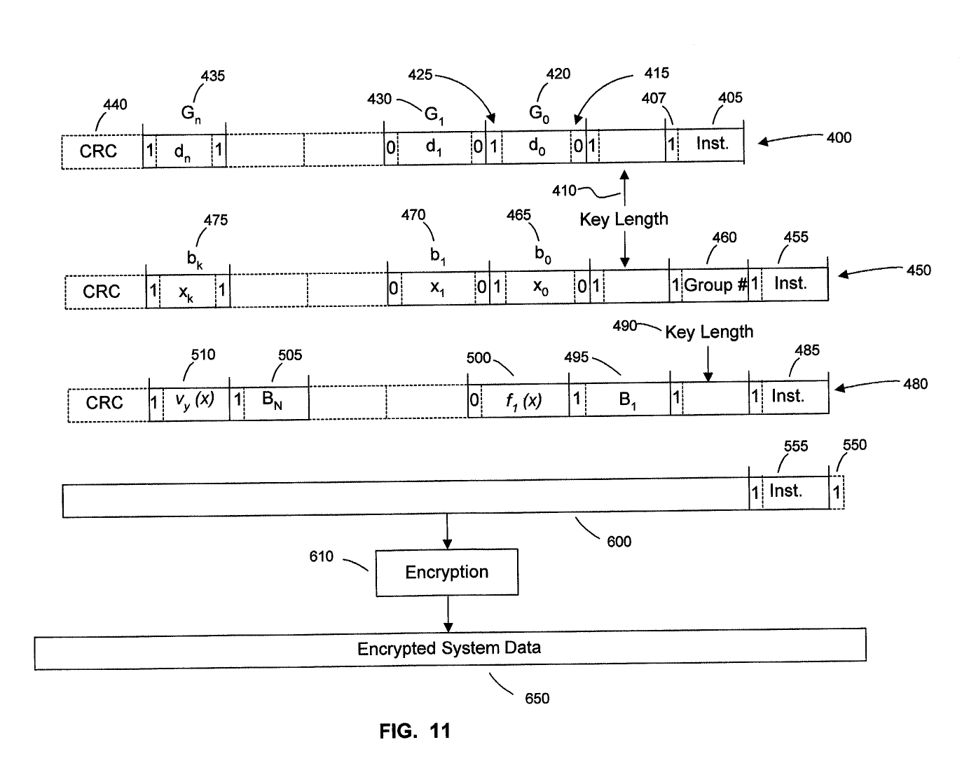

FIG. 11 illustrates some of the suggested protocol formats that can be used to modify and update the encryption and decryption functionality. The first protocol format 400 essentially represents an instruction that exchanges information between the said host and the remote about the exact bit location of each of the Group Bits in a random number. Using a unique binary value, the first 7 bits of field 405 represent the instruction that prompts either host or remote to properly update and modify the number of the assigned Group Bits along with their assigned bit locations in a random number. The last bit of every byte (for example, bit field 407) can be reserved and interpreted as an extension bit. A value of 1 in the said field indicates that the instruction is contained in the byte field 405. A value of 0 indicates that the instruction field extends to include the next adjacent byte, 415, thus making the instruction mnemonic field consisted of 14 bits. The length field 410 represents the number of bytes of data that will follow.

With the use of the extension bit, the said length field can be extended to include multiple bytes. It should be noted that the protocol 400 can contain any number of random bits padded after the data bytes. This provision ensures that the length of the protocol 400 can consist of any arbitrary number of bits that may be more suitable for the encryption process. The location of the first Group Number bit, G₀ 420, corresponds to a bit distance of d₀ (defined in number of bits) from a specific boundary line of a random number. For example, the bit field 415 can be used to define a reference boundary line. A bit value of 1 in the said field may be attributed to the starting boundary line located at the right end of the random number, whereas a value of 0 indicates that d₀ is measured in bits from the left end of the random number. The field 425 represents the extended bit field concept. This means that if the value of the said field is 0 then the present d₀ field is extended to include the next 7 bits of the next adjacent byte to represent its value. This simple technique ensures that if the d₀ field needs to represent a large number then it can span to include multiple numbers of the next adjacent bytes. The receiving end accordingly identifies the end of a particular field by finding a value of 1 in the bit field 425. In a similar fashion, all the Group Bits (G₀, G₁ . . . Gₙ) locations are identified by the corresponding d₀, d₁ . . . dₙ, values, respectively. The CRC field 440 may be included to provide an extra protection for data integrity, even though it is the responsibility of the transport layer and the layers below to ensure that the data has been properly delivered.

The next protocol format 450 is used to send the exact location of the binary Function Bits inside a random number exclusively used by a particular Group Number. The field 455 presents the instruction mnemonic reserved for this purpose. The field 460 identifies the particular Group Number for which the corresponding binary Function Bits location in a random number needs to be identified. The length field 410 represents the total data bytes to be followed. As mentioned earlier, any number of padded bits can be appended after the data bytes to make it more suitable for encryption. In the next field, x₀ represents the distance in bits that can be used to identify the position of the function bit b₀ 465 in any random number. Similarly, the following fields from x_{I} to xₖ represent the bit distance for the corresponding Function Bits b₁ 470 to bₖ 475, respectively.

The protocol format 480 provides a way to exchange information about the Function Bits binary numeric value and the associated logical or mathematical function to be performed on an information segment. The field 485 presents a unique instruction for this purpose. The length of field 490 shows the number of data bytes to be followed. The field B1 495 identifies the Function Bits binary numeric value with the associated number value for the function f₁(x) which is included in the next field 500. Similarly, all the Function Bits binary numeric values and the associated functions with each of these values can be mutually updated and modified between a host and a remote. As will be appreciated by those skilled in the art, a number of different instructions, protocols format and methods can be employed to exchange any type of configuration parameters, consistent with the concepts and teachings of the present invention.

The packet 600 can contain any type of protocol format in it. A single bit field 550 is appended with the value of 1 to indicate that the packet 600 carries system information and not user's data. As discussed with reference to FIGS. 9 and 10, the encryption functions 610 operates on packet 600 and the resulting packet 650 does not disclose any indication to an eavesdropper that the said packet contains user's information or system information. On the receiving side, the appropriate decryption functions are performed to restore the system information packet along with its bit value of 1 in the field 550. The receiving end processes the system packet accordingly by identifying the instruction mnemonics.

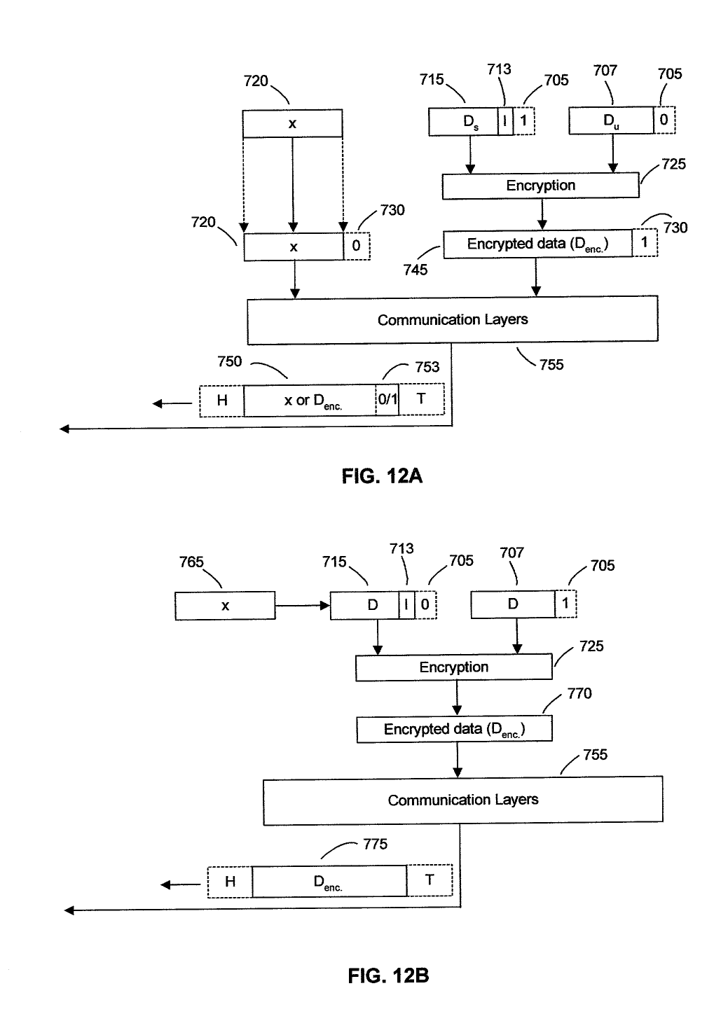

FIGS. 12A & B illustrate two different methods for sending a random number from the remote ‘B’ 5 to the host ‘A’ 1. In the first method as illustrated in FIG. 12A, a system information segment Dₛ 715 and a user information segment Dᵤ 707 are differentiated through the use of single bit field 705. The bit field value set to 1 indicates a system information segment whereas a bit value of 0 indicates a user's information segment. The both information segments go through the encryption process 725 and the encrypted information segment 745 is produced. The remote ‘B’ 5 inserts another single bit field 730 with a bit value of either 1 for the encrypted information segment or 0 for a seed random number 720. The lower communication layers 755 transmit the segment 750 which also carries the bit field 753. The said bit field value differentiates between an encrypted information segment and a seed random number. The host ‘A’ 1 receives the said packet and depending upon the bit value field 753 differentiates between the random number 720 and the encrypted information segment 745. If the received packet 750 contains a random number then the receiving host ‘A’ 1 directly processes this number and identifies the corresponding functions and their inverse to properly decrypt the next train of information segments that it expects to receive from the remote ‘B’ 5.

As it can be seen, the advantage of using this method is that the receiving host ‘A’ 1 does not perform any decryption process to extract the random number. The random number is readily available to be used. The disadvantage is that an eavesdropper can look into the transmitting packet and find out whether the packet contains an information segment or a random number. The hacker may try to guess the designated bit locations in the random number which contain the information about the Group and Function Bits.

A more secure way of transmitting the random number is presented in FIG. 12B. In this technique the seed random number ‘x’ 765 is identified through a unique instruction mnemonic 713 and is processed as a part of system information segment 715. A bit value of 0 in the bit field 705 indicates a user information segment whereas a bit value of 1 in bit said field 705 is reserved for a system information segment. The encryption process 725 operates on both types of information segments and the resulting encrypted information 770 does not disclose any information that can be used by an eavesdropper to differentiate between a random number and user information. The receiving host ‘A’ 1 decrypts the information packet 775 and then identifies between the system or user's information segment. Using the instruction mnemonics it can determine the transmitted seed random number ‘x’ 765.

The present invention also provides a very secure and robust mechanism to exchange passwords between transmitting and receiving devices. In addition to exchanging passwords the participating devices can frequently authenticate one another, if desired, during communication sessions. In conventional encryption schemes a password segment is normally treated as a regular information segment. As it can be appreciated that the secure transmission of a password among the communication devices is of utmost important. If a hacker succeeds in decrypting a segment containing password information then its malicious use on users' network resources can be devastating. Therefore, it is highly desirable that password information should be exchanged with higher security requirements and considerations. To accomplish this the present invention presents a unique way of first diffusing and mapping the information of the individual bits that collectively form the password into an arbitrary binary bit segment. This procedure ensures that password segment information does not cluster into any particular location with an arbitrary binary bit segment. Once the individual bits belonging to the password segment are diffused then the resulting arbitrary binary bit segment can be processed for encryption through the procedures as discussed in this invention.

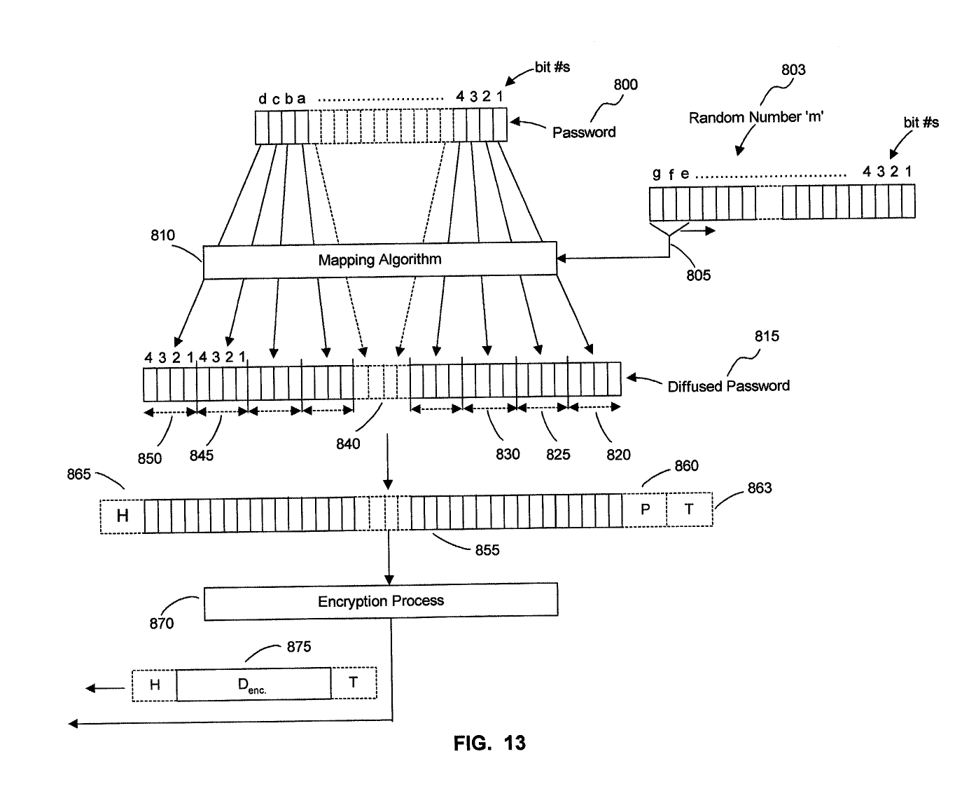

Referring to FIG. 13, there is shown a password information segment 800 consisting of an arbitrary ‘k’ bits which needs to be diffused through the operation of the mapping algorithm 810. The both remote ‘B’ 5 and the host ‘A’ 1 contain the exact same seed random number ‘m’ 803 which resulted from the execution of the last encryption process. The individual bits values constituting the said random number, for all practical purposes, are also random in nature. The mapping algorithm 810 utilizes the information contained in the individual bits of the seed random number ‘m’ 803 to map the individual bits of the password segment 800 to produce a diffused password segment 815. As will be appreciated by the people skilled in the art there can be many different schemes and methods that can be used to produce a diffused password 815 through combining the information of the password segment 800 with the information contained in the random number ‘m’ 803.

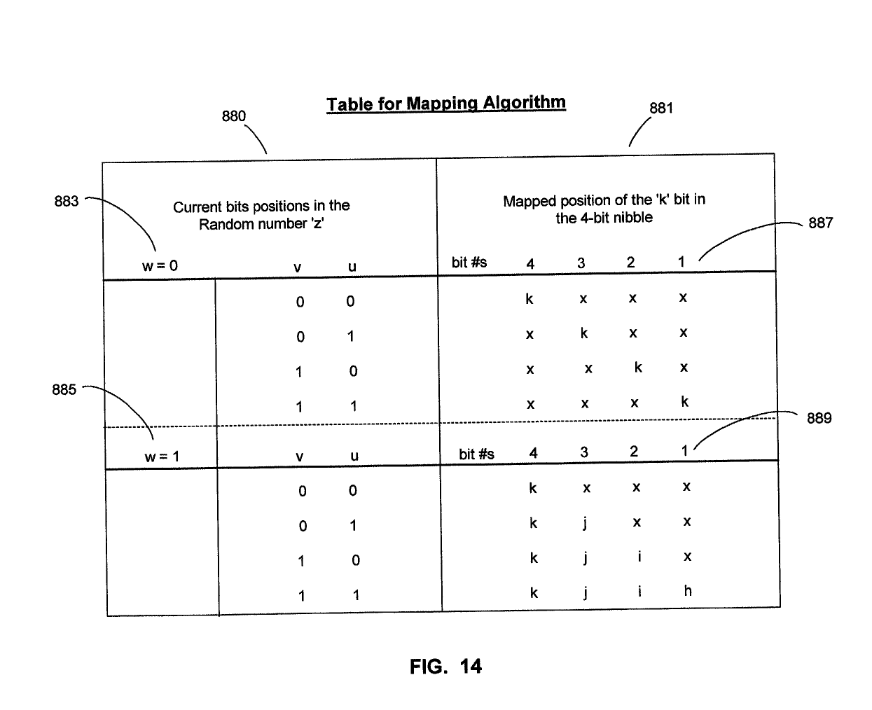

The following presented schemes are for illustration purposes and, nevertheless, limit or restrict the use of the other schemes or methods that can be used to diffuse a password segment. In one embodiment as presented in FIG. 13, the bits from the left boundary of the random number ‘m’ 803 are read as a window of three bits, ‘w’, ‘v’, and ‘u’, by the mapping algorithm 810. The information contained in the three said bits decides how to map one or more of the four bits ‘k’, ‘j’, ‘i’, and ‘h’, of the password segment 800 into the first 4-bit nibble 850. The said 3-bits window slides towards the right on the random number ‘m’ 803 in steps of single or multiple bits. The both remote ‘B’ 5 and host ‘A’ 1 must agree in advance on using the same incremental bit(s) steps. FIG. 14 illustrates a table which has two columns, 880 and 881. The column 880 illustrates the current position of the 3-bit window with all the possible outcomes of the respective three bits, ‘w’, ‘v’, and ‘u’. If the value of the bit ‘w’ is ‘0’ then the mapping algorithm 810 decides, as shown in column 881, to map only ‘k’ bit into one of the four bits of the 4-bit nibble 850. The four possible outcomes of the two bits ‘v’ and ‘u’ determine which bit position of the said 4-bit nibble should be selected to map the ‘k’ bit value. The remaining three unoccupied bits values are filled with random bits values ‘x’.

In the event the bit ‘w’ has a value of ‘1’ 885 then the lower half portion of the said table determines how one or more of the bits, ‘k’, ‘j’, ‘i’, and ‘h’, are going to be mapped into the 4-bit nibble 850. The four possible outcomes of the ‘v’ and ‘u’ bits determine how many number of bits (‘k’, ‘j’, ‘i’, and ‘h’) are going to be mapped into the 4-bit nibble 850. The unoccupied bits, if any, are filled with random bit values.

This process is repeated as the 3-bit sliding window 805 advances towards the right in the incremental steps of one or multiple bits over the random number ‘m’ 803. In the next round the Mapping Algorithm 810 maps the next single or multiple bits of password segment into the next 4-bit nibble 845 and so on. It should be observed that if the 3-bit sliding window reaches at the end boundary of the random number ‘m’ 803 then the said window rolls back to the initial starting location and continues this process until all the bits in the password segment 800 are mapped into the diffused password segment 815. The resulting diffused password segment 815 contains all the individual bits information of the original password segment 800 at dispersed bot locations. As will be appreciated, each time the password segment 800 is mapped to the diffused password segment 815, the refreshed and the newly updated seed random number determines and dictates the exact locations of the individual bits of the original password segment 800 into the diffused password segment 815. Also, this procedure produces a variable length diffused password segment 815 each time the password segment 800 is transmitted.

Referring back to FIG. 13 the said diffused password segment is appended with the proper header 865, padding field 860, if necessary, and the ending trailer 863. The header 865 may contain the indication about the type of the information carried and the length of the padding field. The resulting information segment 855 is delivered for encryption to the encryption processor 870. Finally, after the encryption procedure the encrypted data segment 875 is delivered to the lower communication layers for a guaranteed delivery to the receiving host ‘A’ 1.

The receiving host ‘A’ 1 performs the reverse procedures by using the exact same seed random number and the identical mapping algorithm. As a result, the host ‘A’ 1 recovers the password segment and then makes a comparison with the password segment of the user already stored in the system. If they match, then appropriate permission to access specific system resources is granted, otherwise, the access request is denied.

As it is observed from the preceding discussion, the method presented above ensures a very highly secure delivery of users' passwords who seek authentication from the host ‘A’ 1. Once a user is authenticated through password comparison it may be necessary to frequently authenticate the user access for the communication session established between the remote ‘B’ 5 and the host ‘A’ 1. The above presented technique also provides an excellent way to accomplish this task.

Referring back to FIG. 13, an authentication procedure can be easily established by interchanging the role of the password segment 800 with that of the seed random number ‘m’ 803. In other words, the individual bits of information in the said seed random number are diffused by using the user's password segment 800. In this case, the 3-bit window (for example, ‘w’, ‘u’, and ‘v’ bits) slides over the password segment to determine how the individual bits in the current seed number should be diffused. The resulting diffused random number segment is treated as an information segment and is encrypted accordingly. As the receiving host ‘A’ 1 processes the received segment it extracts the seed random number through the use of the user's authenticated password and the mapping algorithm. For authentication to be successful, the received seed random number must match with the host seed random number. It should be observed that the during the authentication process the information contained in the individual bits of the password segment does not leave the remote ‘B’ 5. Only the individual bits values information of the password segment is used by the mapping algorithm to determine how the individual bits of the random number should be diffused. As a result the stated procedure provides a very secure way of authentication.

While the particular invention has been described with reference to illustrative embodiments, this description is not meant to be construed in a limiting sense. It is understood that although the present invention has been described in a preferred embodiment, various modifications of the illustrative embodiments, as well as additional embodiments of the invention, will be apparent to persons skilled in the art upon reference to this description without departing from the spirit of the invention, as recited in the claims appended hereto. Thus, for example, it should be apparent to one of ordinary skill in the art that the security system of the present invention may be applied in conjunction with enclosed spaces which inhibit entry and/or exit such as a vehicle,-door, building entrance, safe, desk drawer or jail cell, and the like. The invention detailed herein is, hence, applicable to other secured enclosed spaces or secured switching mechanisms requiring security for deterring theft. Moreover, the present invention is also applicable to software security from piracy, formats requiring the storage of personal or secured information thereon. It is therefore contemplated that the appended claims will cover any such modifications or embodiments as fall within the true scope of the invention.

All of the U.S. Patents cited herein are hereby incorporated by reference as if set forth in their entirety.

What is claimed as being new and desired to be protected by Letters Patent of the United States as follows:

1. A method for operating a digital information processing system that encrypts information from a plurality of remote processors to a host processor or vice versa the method comprising processor executed steps of:
at the host and the remote processors before the start of encryption procedure:
means for assigning and mutually agreeing upon, a pre-determined number of bits that are located at pre-determined and specific positions, called Group and Function Bits, within a seed binary bit segment consisting of any length;
means for defining a plurality of function pool containing any type of mathematical or logical functions of any complexity;
means for establishing a unique relationship between the functions defined in the first pool with the functions defined in the second pool sequentially identical at both the host and the remote processors;
means for defining a number ‘N’ which indicates the total number of rounds used for encryption/decryption process.
at the remote processor:
(a) means for generating and sending a seed arbitrary binary bit segment consisted of any length to the host processor;
(b) means for processing the seed arbitrary binary bit segment at the remote processor;
(c) means for producing a numeric number value based on the bit values of the Group and Function Bits as defined in the said arbitrary binary bit segment;
(d) means for selecting a single or plurality of mathematical or logical functions from the first pool based upon the numeric number value of step (b);
(e) means for identifying the corresponding single or plurality of mathematical or logical functions from the second pool;
(g) means for encrypting the digital information segment through operating single or plurality of mathematical or logical functions selected from the second function pool as described in step d;
(f) means for encrypting the arbitrary binary bit segment through operating single or plurality of mathematical or logical functions selected from the first pool as described in step c;
(h) means for replacing the seed arbitrary binary bit segment with the encrypted arbitrary binary bit segment and using it as a new seed arbitrary binary bit segment; and
(i) means for repeating the steps (b) to (h) ‘N’ times and then transmitting the resulting encrypted digital information segment to the said host.

2. The method and system according to claim 1 wherein the said method comprising processor executed steps of:
at the host processor:
(a) means for receiving and identifying the seed arbitrary binary bit segment from the said remote processor;
(b) means for processing the seed arbitrary binary bit segment;
(c) means for producing a numeric number value based on the bit values of the Group and Function Bits as defined in the said arbitrary binary bit segment;
(d) means for selecting a single or plurality of mathematical or logical functions from the first pool based upon the numeric number value of step (c);
(e) means for identifying the corresponding single or plurality of mathematical or logical functions from the second pool;
(f) means for identifying the corresponding inverse function for each of the mathematical or logical functions as recognized in step (e) and tabulating the identified inverse mathematical or logical functions entries;
(g) means for encrypting the arbitrary binary bit segment through operating single or plurality of mathematical or logical functions selected from the first pool as described in step d;
(h) means for replacing the seed arbitrary binary bit segment with the encrypted arbitrary binary bit segment and using it as a new seed arbitrary binary bit segment; and
(i) means for repeating the steps (b) to (h) ‘N’ times and appending the inverse function entries resulting from each round into a tabular form.

3. The method and system according to claim 1 wherein the said method for operating a digital information processing system that decrypts information from a plurality of remote processors to a host processor or vice versa, the method comprising processor executed steps of:
at the host processor:
(a) means for receiving the encrypted digital information segment from the said remote processor;
(b) means for decrypting the digital information segment with the last inverse mathematical function entry as found in the table built in step (i) of claim 2;
(c) means for repeating the above step (b) until all the inverse mathematical or logical functions are exhausted as found in the built in table containing the inverse function entries.

4. The method and system according to claim 1 wherein the arbitrary binary bit segment can be a random number consisted of any arbitrary length.

5. The method and system according to claim 1 further comprising;
means for encrypting a seed binary bit segment through operating mathematical or logical functions which can result in a large bit size number; and
means for truncating the resulting large bit size number and reducing it to a pre-negotiated size mutually agreed between the said host and the remote.

6. The method and system according to claim 1 further comprising;
means for re-using the encrypted seed binary bit segment resulting from the previous encrypted round as a new seed binary bit segment for the next encryption rounds; and
means for encrypting the next digital information segments based on the information contained in the new seed binary bit segment.

7. The method and system according to claim 1 wherein the Group or Function Bits can mutually share the same single or plurality of bits located at pre-determined bit positions within a seed binary bit segment of any length.

8. The method and system according to claim 1 wherein any change in the Group or the Function Bits within a seed binary bit segment of any length leads to the selection of same or different set of mathematical or logical functions belonging to the first and second function pools.

9. The method and system according to claim 3 wherein the decryption procedure at the host processor comprises the steps of:
means for identifying the exact same Group or Function Bits as identified by the remote processor through the use of seed arbitrary binary bit segment;
means for identifying the exact same mathematical or logical functions from the first and the second function pools as identified by the remote processor; and
means for identifying single or plurality of inverse mathematical or logical functions corresponding to each of the identified function from the second pool to be utilized for decryption procedure.

10. The method and system according to claim 1 wherein the Group and the Function Bits located within a seed binary bit segment of any length can be uniquely assigned and mutually recognized through the use of any mathematical or logical functions of any complexity.

11. The method and system according to claim 7 further comprising:
means for reassigning and modifying the total number of Group and Function Bits within a seed binary bit segment in relation to the length range of the seed binary bit segment; and
means for selecting and using the same or a different set of mathematical or logical functions based upon the length range of a seed binary bit segment.

12. The method and system according to claim 1 wherein the transmitted encrypted digital information may consist of different number of bits than the original digital information segment.

13. The method and system according to claim 12 wherein the transmitted encrypted digital information segment further comprising:
means for containing a padding header followed by variable number of padding bit fields;
and means for making the total encrypted digital information segment bits exactly divisible by a specific number.

14. The method and system according to claim 1 wherein the remote and host processors mutually adopt and agree upon the use of a set of protocols and instructions to exchange configuration parameters and system information comprising:
means for reserving a specific bit at a pre-determined position in an information field such that the said bit value determines if the said information field is extended or span to include another known number of bits in the said field definition;
means for exchanging and modifying the total number of Group and Function Bits and their corresponding bit positions assigned within a seed binary bit segment consisting of any arbitrary length;
means for exchanging and modifying the unique association between Group or Function Bits numeric values and the corresponding mathematical or logical function;
means for exchanging a seed binary bit segment or a random number consisting of any arbitrary length through the use of an instruction format being processed as a part of system information; and
means for using or designing any type of protocols or instructions formats to exchange any type of system or configuration information.

15. The method and system according to claim 14 wherein the remote exchanges the system or configuration information with the host processor or vice versa comprising;
means for receiving a public key from the host processor;
means for encrypting any type of system or configuration information through using the public key of the host processor;
means for transmitting the encrypted information to the host processor; and
means for decrypting the said received information at the host through using the host's private key.

16. The method and system according to claim 13 wherein the mutually adopted and agreed upon set of protocols uses a reserved single bit field appended at a pre-determined position known both to a host and a remote comprising,
means for assigning the first outcome of the said bit value to indicate user's information, and
means for assigning the second outcome of the said bit value to indicate system information.

17. The method and system according to claim 1 wherein the remote and host processors mutually agree on a procedure to verify the accuracy of encryption and decryption procedures, comprising:
means for calculating and appending a unique digital signature field reflecting the information contents of a digital information segment before the start of the encryption procedure at the remote processor;
means for calculating and verifying the same unique digital signature after decrypting the received digital information segment at the host processor; and
means for initializing different set of procedures if the verification process fails.

18. A method and system according to claim 1 wherein the remote and host processors mutually agree on a procedure to verify that the encrypted digital information is being delivered to an authenticated processor and the encryption/decryption procedures are working properly, comprising:
means for calculating and retaining a unique digital signature reflecting the information contents of a digital information segment before the start of the encryption procedure at the remote processor;
means for calculating the same unique digital signature after decrypting the received digital information segment at the host processor; and
means for encrypting and transmitting the said digital signature back to the originating remote processor;
means for comparing and verifying the received digital signature with the retained digital signature at the remote processor; and
means for initializing different set of procedures if the said verification process fails.

19. The method and system according to claim 1 wherein the type of digital information segment contains password information further comprising:
means for using any information contained within a random number to identify and determine specific bit locations in an arbitrary binary bit segment; and
means for mapping single or plurality of bits belonging to the password information segment into the said specific bit locations of the arbitrary binary bit segment.

20. The method and system according to claim 1 wherein the type of digital information segment contains authentication information further comprising:
means for using any information contained within a password information segment to determine and identify specific bit locations in an arbitrary binary bit segment; and
means for mapping single or plurality of bits belonging to a random number segment into the said specific bit locations of the arbitrary binary bit segment.

21. A method for operating a digital information processing system that encrypts information from a plurality of transmitting devices to a receiving device or vice versa the method comprising processor executed steps of:
at the transmitting device:
means for generating a seed random number consisting of any arbitrary length and transmitting the said random number to the receiving device;
means for using the information contained in the random number to identify single or plurality of unique mathematical or logical functions identical at the both transmitting and the receiving devices;
means for encrypting any type of digital information consisted of any arbitrary length segment through operating the mathematical or logical functions;
means for encrypting the seed random number through operating the mathematical or logical functions and declaring the resulting number as the seed random number for the next round;
means for identifying the number of encryption rounds, N, through the use of any information means mutually agreed between the transmitting and the receiving devices; and
means for repeating the encryption process on the said digital information segment and the said random number for N number of rounds.

22. A method for operating a digital information processing system that decrypts information from a plurality of transmitting devices to a receiving device or vice versa the method comprising processor executed steps of:
at the receiving device:
means for receiving and identifying the seed random number of an arbitrary length from the transmitting device;
means for identifying the number of encryption rounds, N, through any means mutually agreed between the transmitting and the receiving devices;
means for using the information contained within the specific bits of the seed random number to identify a single or plurality of unique mathematical or logical functions;
means for identifying single or plurality of inverse functions corresponding to each of the identified mathematical or logical functions;
means for decrypting the received digital information segment through operating single or plurality of inverse functions;
means for encrypting the seed random number through operating the mathematical or logical functions and declaring the resulting number as the seed random number for the next round; and
means for repeating the decryption process on the received digital information segment for N number of rounds to remove any effects of encryption on the said digital information segment.
